(19) United States
(12) Patent Application Publication
(10) Pub. No.: US 2015/0307342 A1
(43) Pub. Date: Oct. 29, 2015

(54) Ultimate Equine Training Lines

(71) Applicant: Gina Kathleen Pierce, Clearbrook, MN (US)

(72) Inventor: Gina Kathleen Pierce, Clearbrook, MN (US)

(21) Appl. No.: 14/263,401

(22) Filed: Apr. 28, 2014

(51) Int. Cl. B68B 1/00; B68B 1/04

(52) U.S. Cl. CPC B68B 1/00; B68B 1/04

(57) ABSTRACT

A set of training lines for efficiently helping into aid in the training of horses, no matter what the discipline, replacing the use of many different instruments and devices for such training, The Ultimate Equine Training Lines generally includes of braid pieces of polypropylene rope. Two 7 foot pieces with a scissor hook that swivel, and loop on the opposite ends. Two 16 foot pieces with scissor hooks that swivel, and loops on the opposite ends, and one 4 foot piece with scissor hooks that swivel, on each end. The pieces can be re arranged in different manners to be used as but not limited to seven different devices, such as long line, ground driving reins, lunge lines, draw reins, side reins, rein, and a tie down by adjusting them accordingly and put in proper placement for the desired use, with only one set of Training lines.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to devices for training horses and more specifically it relates to lines and ropes and reins used to effectively work and train a horse, using only one set of lines instead of many different products specified for each use.

2. Description of the Related Art

Any discussion of the related art through the specification should in no way be considered as an admission that such related art is widely known or forms part of common general knowledge in the field.

Horses have been used for many years for pleasure, showing, trail riding, jumping and work. All horses in every discipline must be trained accordingly. Some horses require different types of training but most all trainers use some sort of lines, ropes or instrument to train to their desired discipline.

Some of these instruments include but are not limited to Long Lines, Lunge lines, Ground Driving Reins, Draw Reins, Side Reins, reins, and Tie Down,

The Ultimate Equine Training Lines comes in 5 pieces of different length, so they can be hooked and interchanged to perform all the same tasks as the instruments above with only one set of lines. Making it not only safer and more efficient way by losing the risk of getting tangled in to long of lines when the length needs to be shorter, but also more efficient and less costly because you only require the one set of lines to do all the functions of line training.

### BRIEF SUMMARY OF THE INVENTION

The general purpose of the invention is to provide several different uses of training with one set of lines. The invention generally relates to horse training lines that can be made into and uses as Long Line, Ground Driving Lines, Lunge lines, Draw Reins, Side Reins, Reins, and Tie Down, with a plurality of hooks and loops for the placement of the lines to the horses bit, D rings, or each other creating the desired use of the lines.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at the least one embodiment of the invention in detail, it is to be understood that the invention is not limited in its application to the details of construction or to the arrangements of the components set forth in the following description or illustrated in the drawings, The invention is capable of other embodiments and of being practiced and carried out in various ways. Also, it is to be understood that the phraseology and terminology employed herein are for the purpose of the description and should not be regarded as limiting.

The object is to provide lines that efficiently train a horse in many different uses and disciplines.

Another object is to provide the use of Long Lines while training the horse by attaching the line in the appropriate places.

Another object is to provide the use of Ground Driving Lines, while training the horse by attaching the lines in the appropriate places.

Another object is to provide the use of Lunge Lines, while training the horse by attaching the lines in the appropriate places.

Another object is to provide the use of Draw Reins, while training the horse by attaching the lines in the appropriate places.

### BRIEF DESCRIPTION OF THE DRAWINGS

Various other objects, features and attendant advantages of the present invention will become fully appreciated as the same becomes better understood when considered in the conjunction with the accompanying drawings, in which lie reference characters designate the same or similar parts throughout the several views, and wherein.

FIG. 1 is a perspective view of the invention laid out as if attached to the horse in full long lines, also including the caveson and double snap hook that is used sometimes but not related to the invention.

FIG. 2 is a perspective view of the invention showing how to attach said lines for the use of long lining.

FIG. 3 is a perspective view of the invention showing how to attach said lines for the use of ground driving.

FIG. 4 is a perspective view of the invention showing how to attach said lines for the use of a lunge line.

FIG. 5 is a perspective view of the invention showing how to attach said lines for the use of draw reins.

FIG. 6 is a perspective view of the invention showing how to attach said lines for the use of side reins.

FIG. 7 is a perspective view of the invention showing how to attach said lines for the use of reins.

FIG. 8 is a perspective view of the invention showing how to attach said lines for the use of a tie down.

### DETAILED DESCRIPTION OF THE INVENTION

### A. Overview

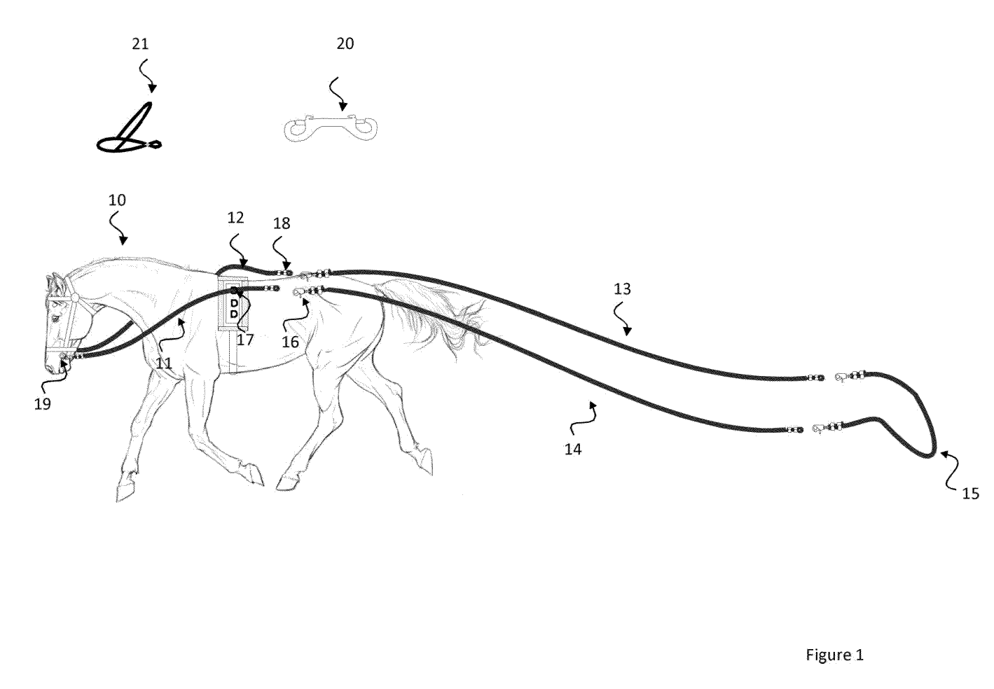

Turning now descriptively to the drawings, in which similar reference characters denote similar element throughout the several views, FIGS. 1 through 8 illustrate The Ultimate Equine Training lines on the horse 10, with five different pieces to be place in such a manner to get desired effect. This drawing shows them fully stretched out along with a caveson 21 and double snap hook 20 used but not related to the training line.

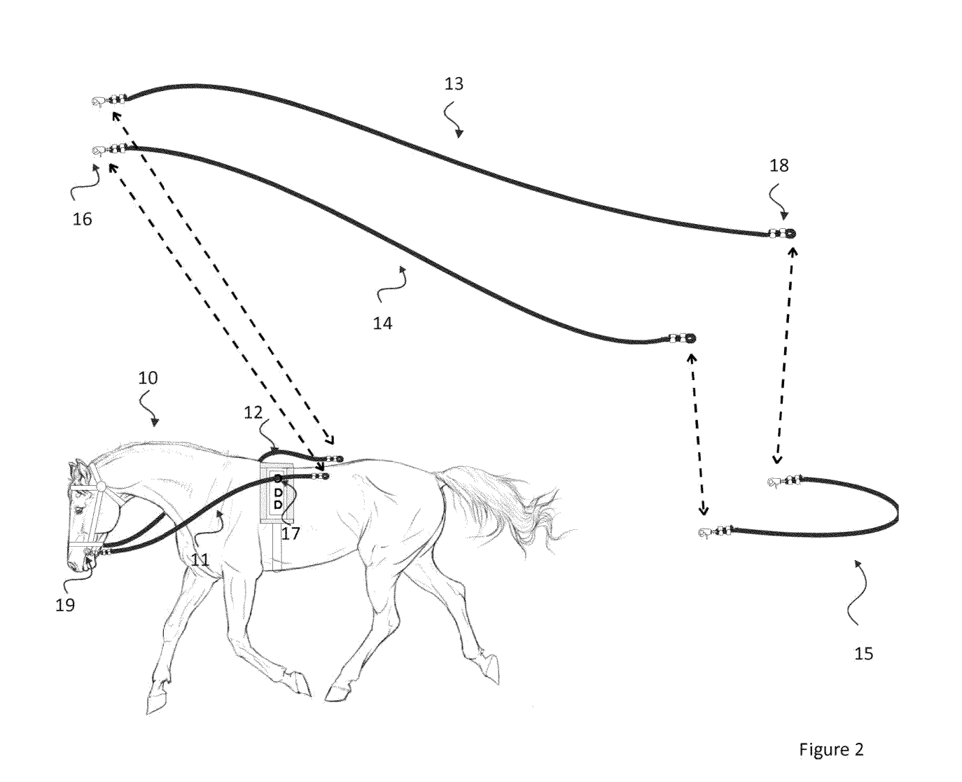

### B. FIG. 2

The horse 10 in this figure is showing instructions for setting up training long lines. With all five pieces to be place in such a manner to get desired effect, with 11 & 12 the two seven foot pieces with 16 scissor snaps that swivel to keep line from twisting to be placed onto the horse's 10 bit, 19 Then putting them threw the D rings 17 of the surcingle then Then connecting the scissor swivel snap 16 of the two sixteen foot pieces 13 & 14 to the loops 18 of the two seven foot pieces 11 & 12. This is done on both sides of the horse 10. Then proceeding with connecting the one four foot piece's 15 scissor swivel snaps 16 on each end to the loops 18 of the two sixteen foot pieces 13 & 14, now creating training long lines.

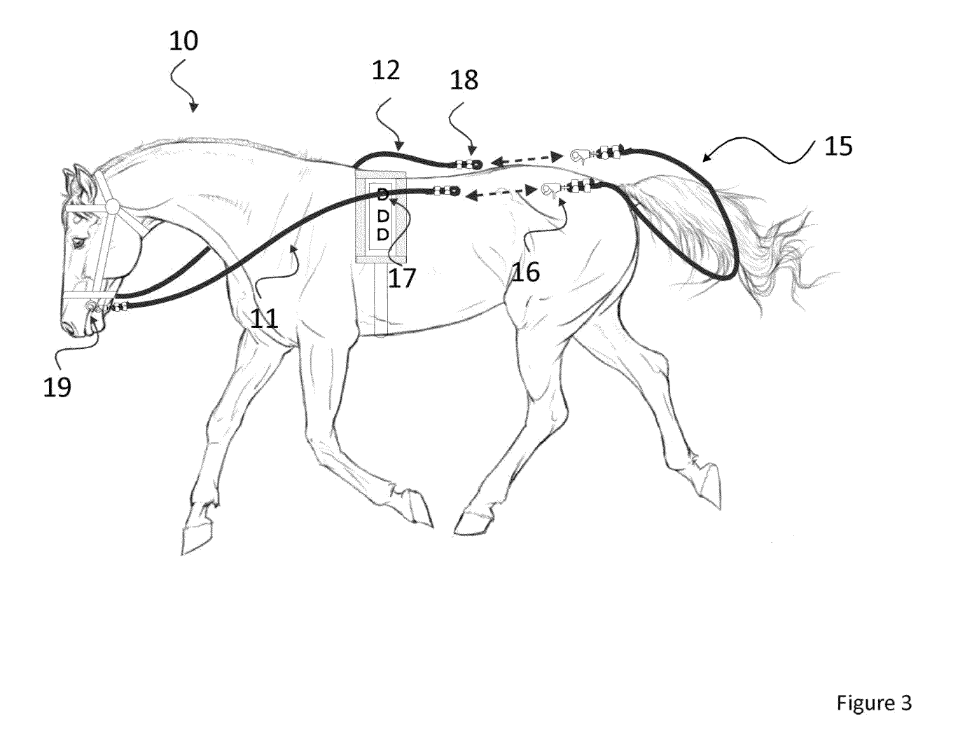

### C. FIG. 3

The horse 10 in this figure is showing instructions for setting up training, ground driving reins. In FIG. 3 using the two seven foot pieces 11 & 12 with the swivel snap hook 16 on the end of each line, attaching them to the bit 19 of the horse 10. Then putting them threw the D rings 17 of the surcingle. This is done on both sides of the horse 10. Then connecting the four foot piece 15 to the loops 18 of the seven foot lines 11 & 12 now creating training ground driving lines.

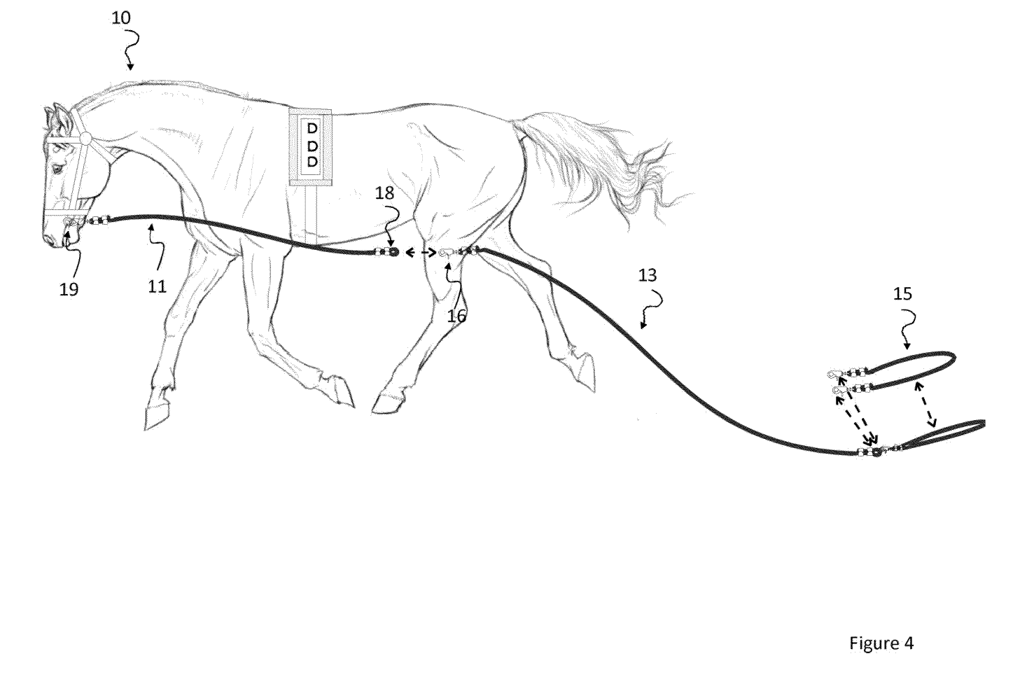

### D. FIG. 4

The horse 10 in this figure is showing instructions for setting up training, lunge line. In FIG. 4 using one of the seven foot pieces 11 and attaching the swivel scissor snap 16 to the bit of the horse 10, then using one of the sixteen foot 13 and attaching its swivel scissor snap 16 to the loop 18 on the seven foot piece 11. Then take the four foot piece 15 and using both ends with swivel scissor snaps 16 attaching both of them to the loop 18 of the sixteen foot piece 13 creating a twenty five foot lunge line.

This figure is showing lunge line length at 25 feet. By changing the lines using the other pieces in a different order or just adding one, or taking one off the horse 10 you can lengthen or shorten the lunge line to the desired length.

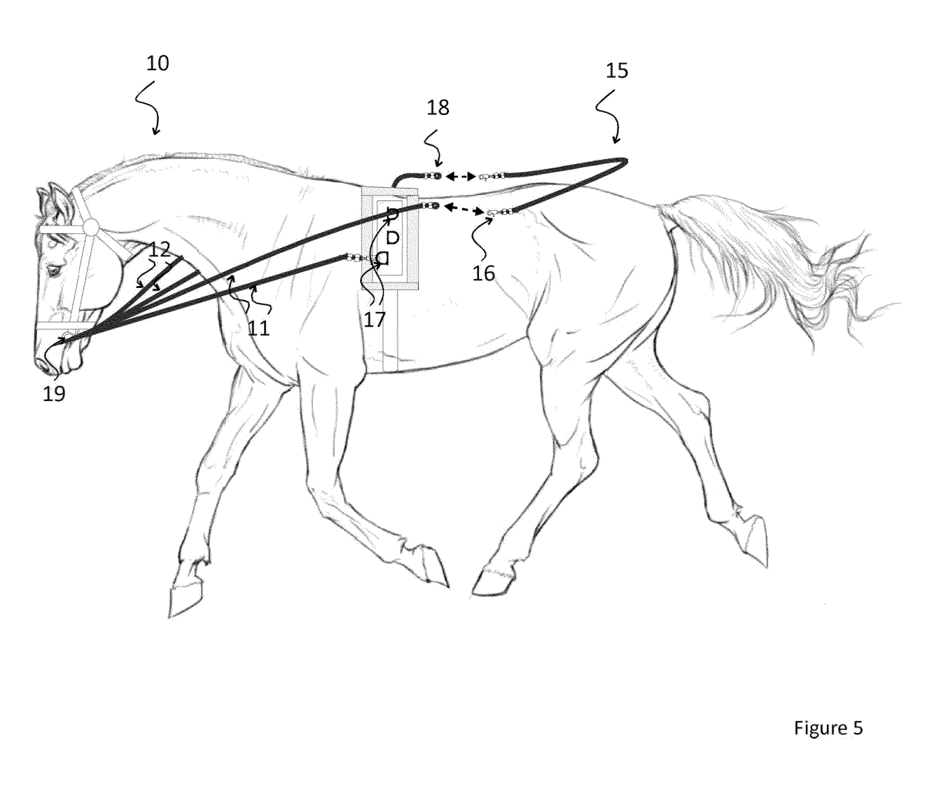

### E. FIG. 5

The horse 10 in this figure is showing instructions for setting up training draw reins to lower the head of said horse 10 and arch at the neck and poll. Using the two seven foot pieces 11 & 12, by attaching the swivel scissor hook snaps to the lower D Ring 17 then bringing them back to the horses bit 19 pulling them threw the bit 19 then back through the upper D ring 17. This is done on both sides of the horse 10. Then attaching the four foot piece 15 swivel scissor snaps 16 to the loops 18 of the seven foot pieces. Creating a set of training draw reins.

This can be done in training while either riding in a saddle or with ground work and a surcingle.

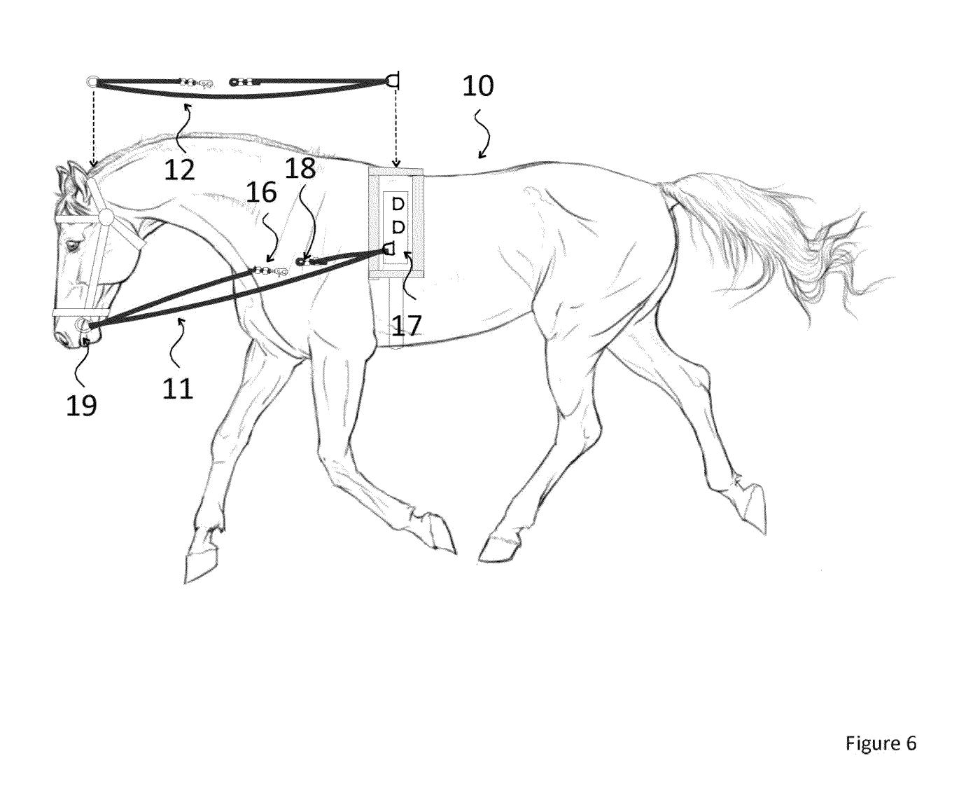

### F. FIG. 6

The horse 10 in this figure is showing instruction for setting up training side reins, keeping the horse's head in the desired position of the trainer. Taking the two seven foot pieces 11 & 12, pull one end of the line threw the bit 19 and the other end threw the D ring 17 and attach the swivel scissor hook 16 to the loop 18 connecting it to itself. This is done on both sides of the horse 10, creating training side reins. This can be done in training while either riding in a saddle or with ground work and a surcingle.

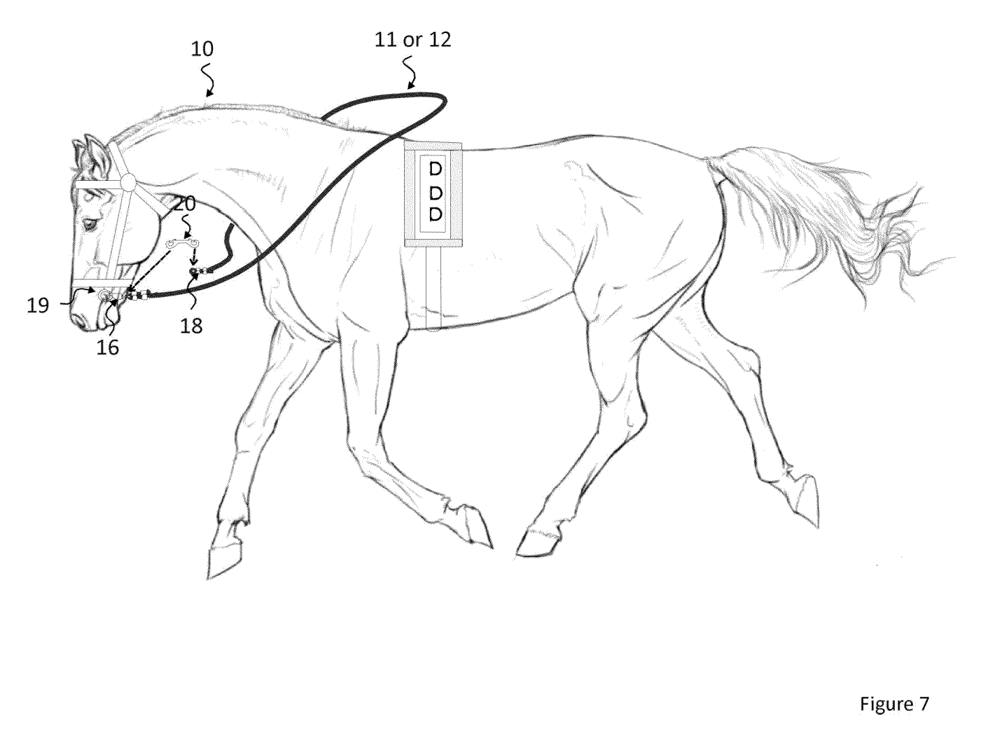

### G FIG. 7

The horse 10 in this figure is showing instructions of setting up reins for steering the horse 10. Using one of the seven foot pieces 11 or 12. Attach the swivel scissor snap hook 16 to one side of the bit 19, then placing it over the horse's 10 neck and attaching a double snap hook 20 to the other end loop 18 and then to the other side of the bit 19.

This is generally used while riding but can also be used while ground training.

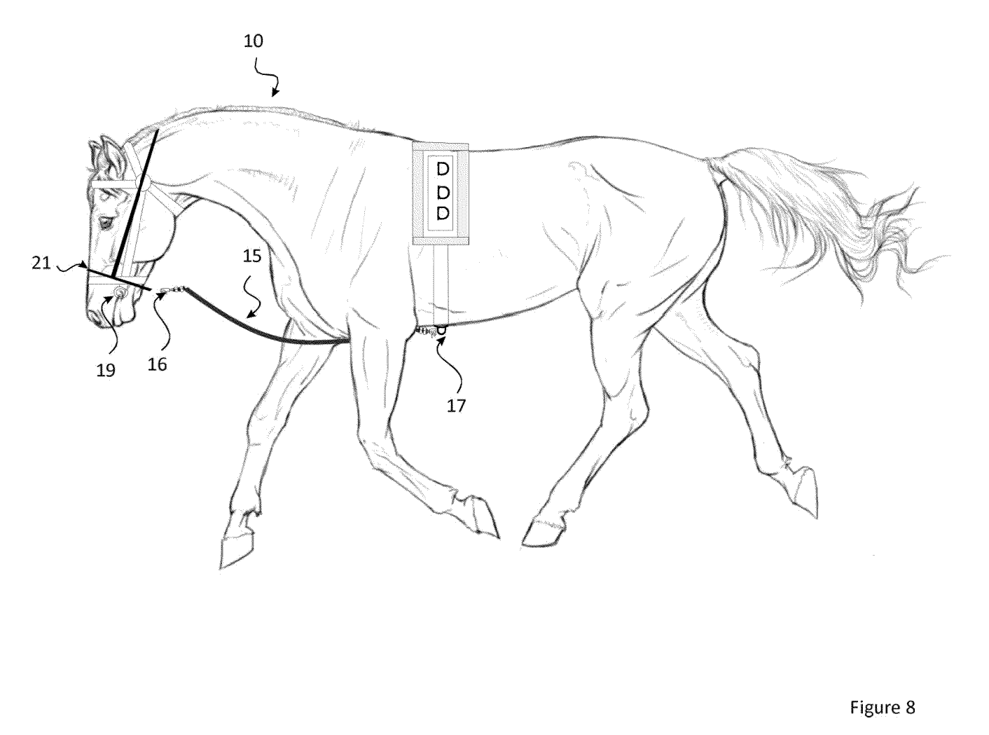

### H FIG. 8

The horse 10 in this figure is showing instructions of setting up a tie down, to keep the horse 10 from throwing his head in the air. Using the one four foot piece 15, then attaching one end of the swivel snap hook 16 to the tie down caveson 21, then with the other end and swivel snap hook 16 attaching it to the D ring 17 on the horses girth.

The tie down can be used while riding or training.

What has been described and illustrated herein is a preferred embodiment of the invention along with some of its variations. The terms descriptions and figures used herein are set forth by way of illustration only and are not meant as limitations. Those skilled in the art of equine training will recognize that many variations are possible within the spirit and scope of the invention, which is intended to be defined by the following claims (and their equivalents) in which all terms are meant in their broadest reasonable sense unless otherwise indicated. Any heading utilized with in the description are for convenience only and have not legal or limiting effect.

1. An equine set of training lines that are three different lengths of line made of ⅜ polypropylene braided rope, comprising of two 7 foot pieces, two 16 foot pieces, and one 4 foot piece, with scissor hooks and loops at one of each end.

2. The equine set of training lines as in claim 1 are interchangeable and can be re arranged so they can be used but not limited to seven different ways.

3. The equine set of training lines as in claim 1 are to be used as long lines when at full length reaching approximately 25 feet, when using all the pieces in there appropriate placement.

4. The equine set of training lines as in claim 1 are to be used as driving lines with when using the two 7 foot pieces along with the 4 foot piece put in their appropriate placement.

5. The equine set of training lines as in claim 1 are to be used as a lunge line of desired length but not more than 50 feet, depending on the number of pieces you use, when put in their appropriate placement.

6. The equine set of training lines as in claim 1 are to be uses as draw reins using two of the 7 foot pieces and the 4 foot piece, in their proper placement. This gently draws the horses head in a down to create the arch in the horse's neck and poll, and bring the top line on the horse to the desired position of the trainer.

7. The equine set of training lines as in claim 1 are to be used as side reins keeping the horses head in a lower position using the two 7 foot pieces looped through the bit, then again through the D rings on either side of the saddle or the surcingle and snapped to the other end of itself.

8. The equine set of training lines as in claim 1 are to be used as reins, using one of the 7 foot pieces by attaching the hook end to one side of the bit, then over the neck of the horse, then using a double ended snap hook attaching it to the look end of the line, then to the other side of the bit.

9. The equine set of training lines as in claim 1 are to be used as a tie down using the 4 foot piece hooking one end to the tie down caveson then the other end to the D ring on the girth. This will keep the horse from throwing their head.

10. The Ultimate Equine Training lines are the only set of lines that can be used for so many functions with one set of lines.

11. The Ultimate Equine Training lines are not limited to what is shown in the drawing or what is described herein. They have many more function making them economical and easier to use then other training lines.
